(19) United States
(12) Patent Application Publication
(10) Pub. No.: US 2013/0054424 A1
(43) Pub. Date: Feb. 28, 2013

(54) E-COMMERCE TRANSACTION SYSTEM AND METHOD FOR INTANGIBLE MERCHANDISES

(71) Applicants: Hung-Yu Chen, New Taipei City (TW); Chun-Yin Liu, New Taipei City (TW)

(72) Inventors: Hung-Yu Chen, New Taipei City (TW); Chun-Yin Liu, New Taipei City (TW)

(21) Appl. No.: 13/591,846

(22) Filed: Aug. 22, 2012

(30) Foreign Application Priority Data
Aug. 26, 2011 (TW) 100130758

(51) Int. Cl. G06Q 30/00

(52) U.S. Cl. 705/27.1

(57) ABSTRACT

An e-commerce transaction system and method for intangible merchandises are provided. The system includes a web portal, a database, a security verification module, a network transmission interface and a server. The method includes the following steps. Firstly the user logs into the web portal to upload or download intangible merchandise, or a demand or an information for the intangible merchandise. The intangible merchandise, the demand and the information are stored in the database. Through the security verification module, login information, transaction procedures and the intangible merchandise are protected, encrypted and verified. The web portal is operated through the server and the network transmission interface.

### CROSS-REFERENCES TO RELATED APPLICATIONS

This non-provisional application claims priority under 35 U.S.C. §119(a) on Patent Application No. 100130758 filed in Taiwan, R.O.C. on 2011, Aug. 26, the entire contents of which are hereby incorporated by reference.

### BACKGROUND

1. Technical Field

The disclosure relates to a method for e-commerce transactions, in particular to an e-commerce transaction platform for intangible merchandises.

2. Related Art

In this well-developed digital era, today electronic products and the internet become essential elements for human's daily life; especially the breakthroughs of network and hardware technologies are pushing information exchanges and interactions between people to a historic summit. Therefore, even without actual physical work or labor, people can still achieve their purposes through the internet; in which the vigorous developments of electronic commerce (e-commerce), becomes an obvious example. Nowadays, various e-commerce transaction platforms are available for consumers; online shopping, online auction and paid video and audio, each have their own broad supply/demand markets respectively. The transacted products above are mostly tangible, even for video and audio products, except for paid downloads or online playback services, the physical video or audio products are purchased online and then delivered to the paid consumers by mails or logistics.

However, for intangible properties or merchandises, only few services are available for consumers' needs; one example is the exchange platform for intellectual properties. Another example is service windows with manpower resources or a knowledgeable team for intangible merchandises. Such an operation model requires establishing an extra backend service team or a knowledgeable team and experts to respond to the user's need or provide corresponding services. Therefore, the cost would be relatively increased. Additionally, when using the operation platform above, the user is not allowed to provide their own works or fulfill the needs of self-creations. Namely, transaction platforms with the conventional operations mentioned able do not resolve the supply/demand problems for the actual users.

### SUMMARY

Accordingly, according to one or more embodiments of the disclosure, an e-commerce transaction system and method provides and discloses a differential electronic commerce transaction mechanism for intangible merchandises, which resolve the problems in the prior art.

In an embodiment of the disclosure, an e-commerce transaction method for intangible merchandises is provided through the following sections. Log in a web portal to upload or download an intangible merchandise, or to upload or download a demand corresponding to the intangible merchandise, or to provide an information correlated or unrelated to the intangible merchandise. Store the intangible merchandise, the demand and the information through a database. Protect, encrypt and verify a login information, a transaction procedure and the intangible merchandise through a security verification module, and operate the web portal through a server and a network transmission interface.

In an embodiment of the disclosure, an e-commerce transaction system for intangible merchandises includes a web portal, at least a database, a security verification module, a network transmission interface and a server. The network transmission interface connects to a public or private network. The web portal is loggable therein through the network transmission interface, so as to upload or download an intangible merchandise, or to upload or download a demand corresponding to the intangible merchandise, or to provide an information correlated or unrelated to the intangible merchandise. The database stores the intangible merchandise, the demand and the information through a database. The security verification module protects, encrypts and verifies a login information, a transaction procedure and the intangible merchandise. And the server is adapted to operate the web portal through the network transmission interface.

The introduced e-commerce transaction system and method accomplish an online e-commerce transaction platform for uploading, sharing and exchanging user-payable self-made self-created intangible merchandises and introductions thereto.

### BRIEF DESCRIPTION OF THE DRAWINGS

The disclosure will become more fully understood from the detailed description given herein below for illustration only, and thus not limitative of the present invention, wherein:

FIG. 1 is a systematic block diagram of an ecommerce transaction system according to an embodiment of the disclosure;

FIG. 2 is an explanatory block diagram of a database in an ecommerce transaction system according to another embodiment of the disclosure;

FIG. 3 is an explanatory flowchart I of an ecommerce transaction method according to another embodiment of the disclosure;

FIG. 4 is an explanatory flowchart II of an ecommerce transaction method according to another embodiment of the disclosure;

FIG. 5 is an explanatory diagram I of an execution architecture for an ecommerce transaction method according to another embodiment of the disclosure; and

FIG. 6 is an explanatory diagram II of an execution architecture for an ecommerce transaction method according to another embodiment of the disclosure.

### DETAILED DESCRIPTION

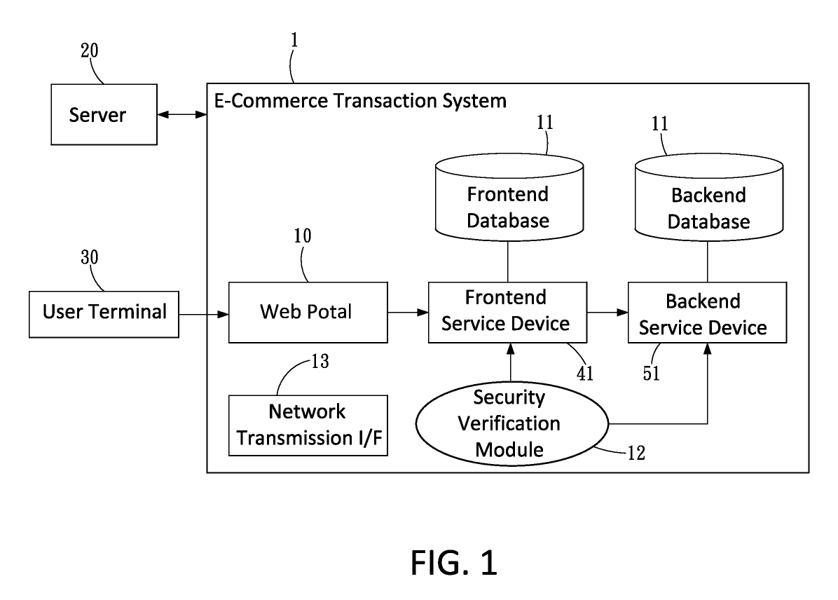

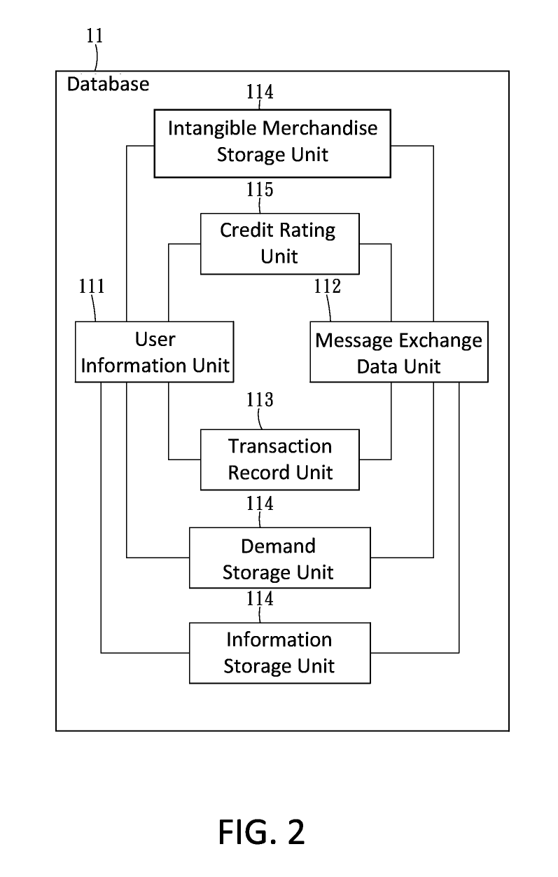

Please refer to FIG. 1 and FIG. 2, wherein FIG. 1 is a systematic block diagram of an e-commerce transaction system according an embodiment of the disclosure, and FIG. 2 is an explanatory block diagram of a database in an ecommerce transaction system according to another embodiment of the disclosure.

E-commerce transaction system 1 includes a web portal 10, a database 11, a security verification module 12, a network transmission interface 13, a server 20, a frontend service device 41 and a backend service device 51.

The web portal 10 is loggable therein through the network transmission interface 13. The web portal 10 is provided for the user to operate procedures of login, register, identification, paid download, paid online playback, editing personal information, amendments, encryption and decryption and certification. The web portal 10 may be realized by a set of online accessible computer software programs and necessary hardware. The web portal 10 may be installed in the server 20 or a standalone computer system independent from the server 20.

One or more databases 11 are provided therein. In the present embodiment, two databases are introduced: frontend database 11 and backend database 11; but the databases introduced here should not be taken as a general limitation to the entire disclosure. The databases 11 may be implemented together with the web portal 10 or the server 20 in a computer system, or may be independent from the web portal 10 or the server 20 in separated computer systems. The database 11 may be realized by a storage device such as volatile or non-volatile memory, accessible as a hardwired embedded or removable storage unit, or an online storage unit.

The security verification module 12 is for protecting, encrypting and verifying one or more login information, one or more transaction procedures and the intangible merchandises.

The frontend service device 41 connects with the frontend database 11, and backend service device 51 connects with the backend database 11. The frontend service device 41 and the backend service device 51 both connects with the security verification module 12; after the user logs into the web portal 10, the user is able to access the frontend service device 41. In general, the frontend service device 41 may be realized by a set of computer operable software programs and necessary hardware, operating as an interface for the user to access the frontend database 11 through the user terminal 30. Likewise, the backend service device 51 may also be realized by another set of computer operable software programs and necessary hardware, operating as another interface for the platform provider to access the backend database 11 through the server 20. The frontend service device 41 and the backend service device 51 are implementable together with the web portal 10 or the server 20 in a computer system, or are independent from the web portal 10 or the server 20 in separated computer systems.

Network transmission interface 13 is connected to a public or private network so that a user or a platform provider can operate the user terminal 30 or the server 20 to establish links with the web portal 10 through the public or private network and the network transmission interface 13 and to operate the web portal 10.

There are one or more servers 20 included therein to provide the operating functions of the web portal 10. The server 20 may be realized by a computer system with necessary operable software programs and hardware.

Herein the user could be a supplier that supplies self-made self-created intangible merchandise, or a demander that needs to download the desired intangible merchandise. Here the intangible merchandise is selected from the group consisting of self-created experiences, knowledge, wisdoms, arts, intelligences, methods, concepts, improvisations, creations, know-how, researches, secret prescription and humanity exploration and any combination thereof.

The demands corresponding to the uploadable or downloadable intangible merchandise, and the information correlated or unrelated to the intangible merchandise are respectively digital electronic files of videos, audios, texts, images, application programs of self-made self-created introductions, sample files, demo files, advertisements and propagandas or any combination thereof. The examples mentioned above are for explanation purposes only, and should not be taken as a general limitation to the entire disclosure.

The database 11 stores the intangible merchandise and various detailed data of the recorded intangible merchandise, the demands and the information. The database 11 also records many personal data such as transaction records, user credit rankings and user information (i.e. personal Identification No., communication information, security verification certificate and various intangible goods belongs to the user). The database 11 further includes a user information unit 111, a message exchange data unit 112, a transaction record unit 113, multiple storage units 114 and a credit ranking unit 115. The multiple storage units 114 are used to store the corresponding intangible merchandises, demands and the information; in detail, the storage unit 114 for storing the intangible merchandises such as experiences, knowledge and wisdoms, and also another storage unit 114 for storing demands and information regarding to the introductions, advertisements and propagandas of the corresponding intangible merchandises.

The embodiment mainly aims to a supply-demand reciprocal mechanism for the “intangible” merchandises. The electronic transaction mechanism disclosed in the embodiment allows the user to “provide” or “acquire” various intangible self-made self-created property without pirating from other people's copyrights (copyrights own by others). These intangible merchandises may achieve commercialization through such transaction mechanism. Additionally the valualization and differentiation of the intangible merchandises allow everyone to express their value variety and characteristic, thereby achieving purposes of self-marketing, exposure, propaganda, benefit or sharing.

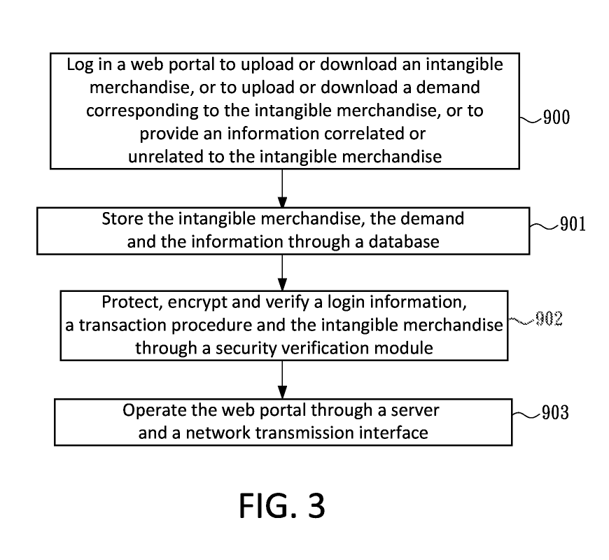

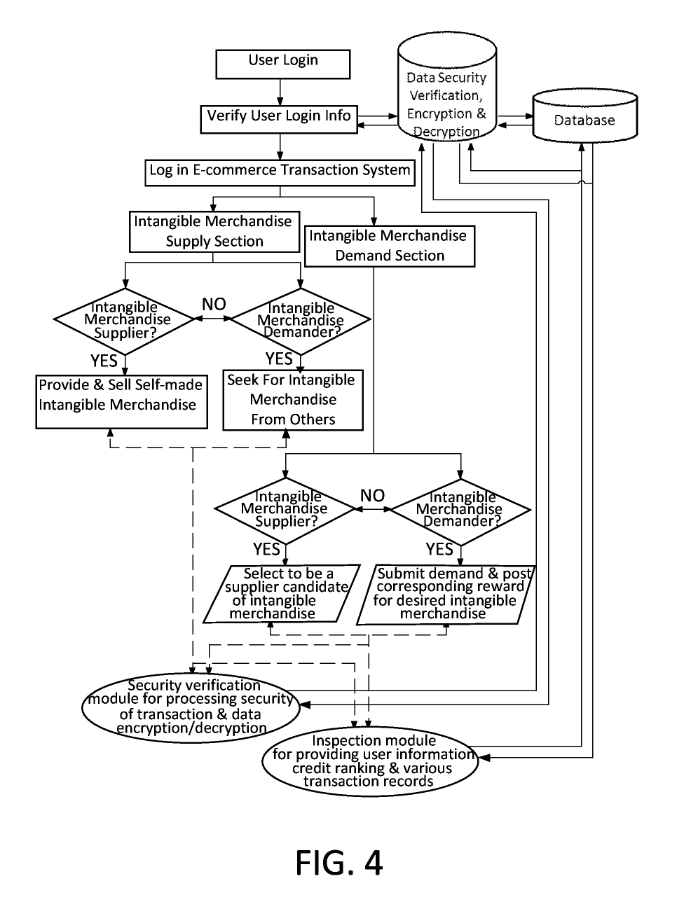

Please refer to FIG. 3 and FIG. 4, in which the method includes the following steps:

Step 900: Provide a web portal 10 for the e-commerce transaction system 1. When the user log in the web portal 10 through the user terminal apparatus 30, the user is able to upload or download the intangible merchandises, or to upload or download a demand corresponding to the intangible merchandise, or to provide an information correlated or unrelated to the intangible merchandise.

Step 901: Store the intangible merchandise, the demand and the information through a database 11.

Step 902: Protect, encrypt and verify a login information, a transaction procedure and the intangible merchandise through a security verification module 12.

Step 903: Operate the web portal 10 through the server 20 and the network transmission interface 13.

The transaction method provides the web portal 10 for the e-commerce transaction system, which is equipped with the server 20 and the network transmission interface 13, as well as the database 11 stored with the merchandises and personal information. When the user enters the e-commerce transaction system 10 through the web portal 10, according to the user's personal demands and purposes, the user is able to play the role as a supplier or a demander.

When operating as a supplier, the user by himself makes and determines the means of according to the personal purposes; the means may be video, audio or text files, application programs or any type of self-made (not other people's intelligence creations), digital media, uploadable as a supplier's an advertisement, propaganda, sample files, demo files or intangible merchandise itself. Therefore, through the transaction method, the user that operates as a supplier is able to announce and market his works for earning profits, so that those demanders understand the content and function of the intangible merchandises provided by the supplier, and thereby determining whether to purchase or not.

Furthermore, a supplier is able to search on the platform for various demands of intangible merchandises submitted by demanders. If the supplier is capable of fulfilling such demands, the supplier may provide to the demander with their own credit ranking, attribute, propaganda, self-recommending information, transaction records, or outlines/abstract for resolving the demands; accordingly the supplier becomes a supplier candidate. After evaluation of the demander on the supplier's credit ranking, attribute, personal propaganda, transaction records, outlines/abstract of the solution for the demands, the demander may purchase the intangible merchandise with the solution or intangible property of the supplier candidate. On the other hand, the supplier candidate receives the rewards and payment announced or posted by the demander. Consequently, the supplier is able to increase his income through his intangible property.

When the user operates as a demander, aside from searching on the e-commerce transaction system 10 for the desired intangible merchandises provided from others, purchasing and downloading for use or using online, the user as the demander may also post his intangible demands and rewards on the platform. Therefore, the suppliers may be attracted to provide corresponding intangible merchandises; and the user as the demander may select from the supplier candidates by evaluating their credit ranking, attribute, transaction records, self-recommending information or outlines/abstract of the solutions for resolving the demands, determine which intangible property mostly fulfills the demands, and meanwhile pay the selected supplier with corresponding rewards. As to the demander, the selected purchases may be multiple-choice.

The aforesaid credit ranking unit 115 provides a method for evaluating the credit ranking of the users of the transaction platform. Each and every user of the e-commerce transaction system 1 may establish their own credit ranking according to the following mechanism.

(1) When the user operates as a supplier, whenever selling out (namely the demander pays and purchases), their own intangible merchandise or property, the supplier receives a positive or negative (in other words satisfied or unsatisfied), ranking from the demander, so as to establish their own credit ranking and attribute trends. These rankings are truly recorded into the database with the classifications of the intangible merchandise and transaction details.

(2) When the user operates as a demander, the details of evaluating the supplier become their own credit ranking. For example, the evaluation on the supplier's intangible merchandises after the demander's purchase is also recorded along with the merchandise classification into the database. Therefore, those received evaluation and given evaluation, along with the detailed classifications, are all the user's direct records, which truly represent every user's credit ranking and attribute trend.

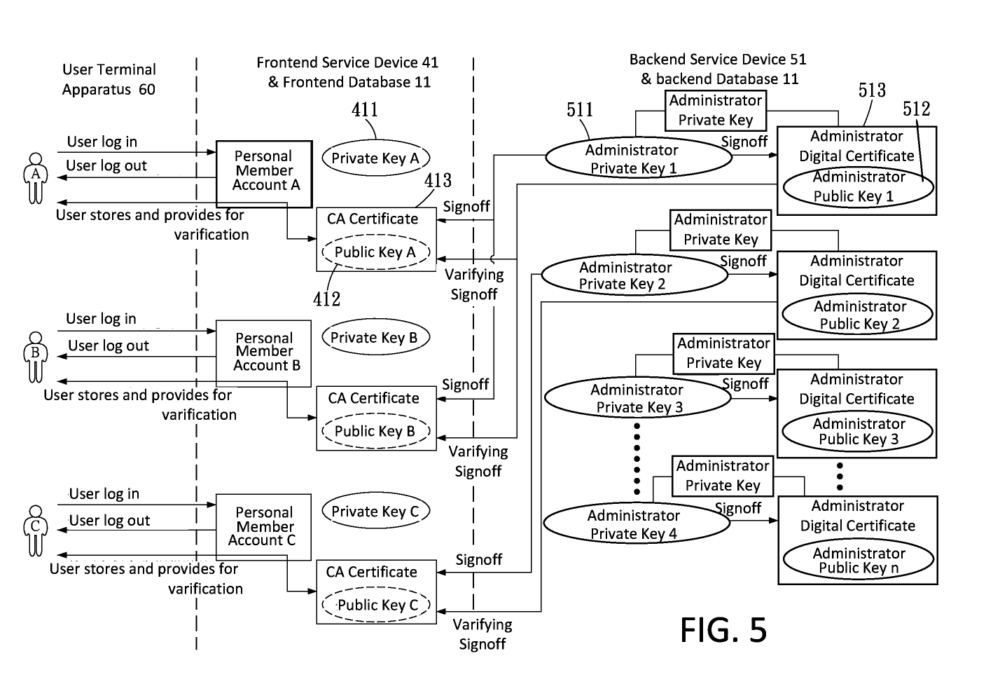

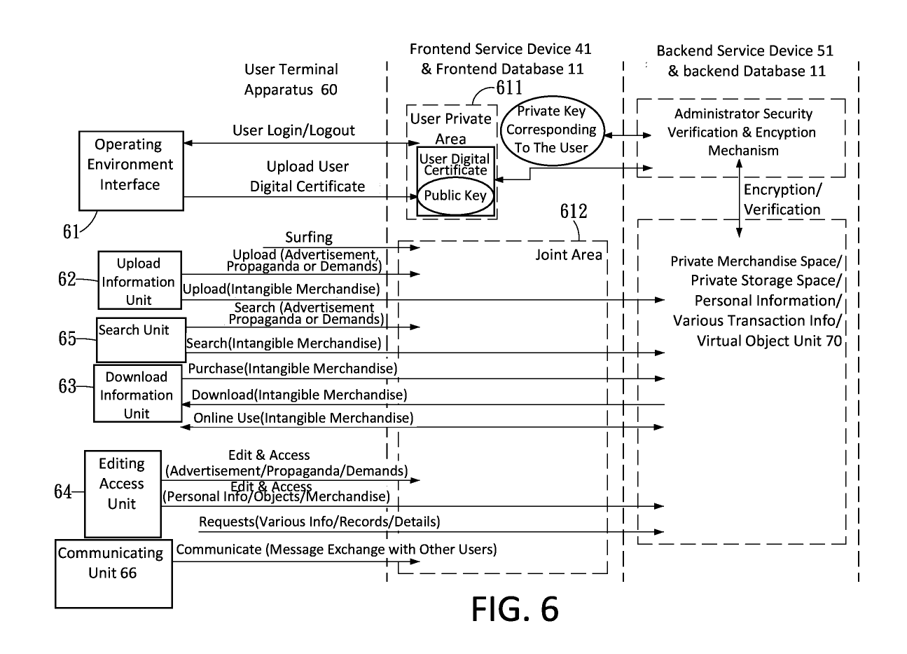

Please refer to FIG. 5 and FIG. 6. In order to achieve demands of instancy and efficiency, the transaction of intangible merchandise is established on the internet to fully develop its features. However, transmissions on the internet require serious considerations of the security; if the protections of the intangible merchandises are broken and the intangible merchandises are massively downloaded and distributed, it would be a tremendous loss for the intangible merchandise suppliers. Accordingly, the transaction method for the intangible merchandise also provides a secured protection mechanism, so that every user may exchange his merchandise under a safe transaction method. The user is able to use the security verification module 12 to protect, encrypt and verify the login information, transaction procedures and the intangible merchandises. During the procedures of paying for purchase, transmitting files, verifying the login information and payment transaction, the user is ensured to use the e-commerce transaction system 1 under a safe and reliable environment.

Firstly, the e-commerce transaction method includes two service mechanisms, namely the frontend service device 41 and the backend service device 51. The frontend service device 41 provides a basic environment after a user logs in. The environment is a low security level environment, which is mainly a joint area 612 that provides functions of uploading and posting propaganda and advertisement related or unrelated to various intangible merchandises, or posting demands for various intangible merchandises (with contents such as texts, videos, audios, flash files, digital electronic files etc.), or providing basic online tools for the user to edit or process the uploaded propaganda, sample file, demo file, advertisement, or various intangible demands, such as the trimming function for trimming audio or video files, or extracting essences from the intangible merchandise for producing the media portions of an advertisement. Moreover, the user is able to initiate procedures for searching and requesting information of various classifications. Here the frontend service device 41 also provides all kinds of communicating mechanisms for the users to interact with each other and exchange messages. Furthermore, this area also provides a user digital certificate 413 (user CA) through the user, which processes decryption procedures or verifies security means, aiming on the downloaded files or information.

Backend service device 51 is a high security level environment that extremely considers security issues. Aside from the intangible merchandises, the backend database 11 stores important information such as user personal information, various transaction details, credit ranking or various virtual objects. If the backend database 11 is broken in, the caused loss would be incalculable. The protection mechanism of the security verification module 12 ensures the independency of every user space to avoid chained attacking; in the meantime the system administrator's independent key is also provided to ensure the authorized certificates are safe and reliable.

Please refer to FIG. 6. The aforesaid backend database 11 includes a virtual object unit 70 that uses the operating means of the virtual treasures and virtual currency as used in online games. This is because aside from online games, another main stream consuming and usage on the internet is online auction; generally the conventional electronic transaction platform is lack of such virtual object mechanism. Accordingly, the disclosure integrates virtual objects into an online electronic transaction platform. By the value adding and consumption boosting characteristics of virtual objects, the virtual object increases the user's willing to use the electronic transaction platform and increase consumption. In the meantime, the platform provider can provide feedbacks and favorable rewards to the user through the virtual objects, so the platform provider and the user are both beneficial from the platform.

Take actual applications of an electronic transaction platform as an example. For a platform provider, when the buyer and the supplier complete a deal, the platform provider may send virtual objects (such as virtual currency or virtual card), to the buyer and the supplier. The users may accumulate the virtual objects through transactions. After the virtual objects are accumulated to a certain amount, the user may exchange for other essential rewards, cash refunds or more value-added services with the platform provider. Therefore, the platform provider is able to stimulate and increase the total amount of the users' transactions. As to the users operating as the buyer and the supplier, aside from accumulating virtual objects/treasures through transactions, the users may exchange or purchase virtual objects/treasures between the users. The virtual objects/treasures allows the users to obtain more benefits from the platform provider, such as rewards/services like reduced transaction fees, reduced publication fees, extension of publication period, additional space for use, extra lottery opportunity and exchange for actual cash or coupons.

The provider of the e-commerce transaction system 1 is able to determine if the virtual objects/treasures are exchangeable, givable or transactable between the users. The actual application depends on the conditions and properties of the transaction platform.

When the user or the platform provider uses the user terminal apparatus 60 to operate the frontend service device 41 or the backend service device 51 through the server 20, user terminal apparatus 60 operates through the operating environment interface 61, the upload information unit 62, the download information unit 63, the editing access unit 64, search unit 65 or the communicating unit 66.

The operating environment interface 61 includes a user private area 611 with functions for the user to log therein and edit personal settings and upload a legal user digital certificate 413. After purchasing, the intangible merchandise is stored into a private space of the frontend service device 41 or the backend service device 51. The user is able to select time, place or interface to download the purchased intangible merchandise.

The operating environment interface 61 includes a joint area 612, provided for the users an area jointly used for services of posting advertisement, sample files, demo files, propaganda or demands, searching, editing and accessing, and interacting/communicating between the users.

The backend service device 51 receives the identification information of the registered user through the user information unit. After the identification information is confirmed legal, a user private key 411 and a corresponding user public key 412 are produced. The user is not able to access the user private key 411 directly; the user private key 411 must be protected and provided through the server 20 according to the corresponding user account.

Accordingly, the user public key 412 signs off and grants a user digital certificate 413 to a user through a dedicated administrator private key 511; the user digital certificate 413 will be provided when next time the user uses any security operations. The signoff of the user digital certificate 413 is verified to confirm its legitimacy by an administrator public key 512 or an administrator digital certificate 513 generated by the administrator private key 511 of the backend service device 51.

Please refer to the following detailed description:

(1) The security mechanism of the backend service device 51 or the server 20 includes one or more administrator private keys 511. In the meantime, one or more administrator public keys 512 are generated by the administrator private key 511. In the meantime, the corresponding administrator private key 511 further signs off and generate one or more administrator digital certificates 513.

(2) Whenever a user is registered as a member, the registered identification information of the user (such as personal identification, contact information and any kind of information suitable for identifying the user's identity), is transmitted to the security mechanism of the backend service device 51 and also stored into the backend database 11. When the user's identification information is confirmed legal, a user private key 411 is generated accordingly; the data length of the key is not specifically limited. The user private key 411 is stored in the server 20 and well protected. The user private key 411 is stored in the server 20 (frontend or backend server) within the security mechanism; and the user private key 411 is also directly corresponds to the login account of the user (i.e. the user space after logging therein) instead of holding by the user for security considerations. The user can not directly obtain the dedicated user private key 411, and have no way to be aware of the actual content in the user private key 411; namely the user private key 411 is only corresponsive when operating through the server 20. When the user logs in using some login information, the server 20 is able to access the user private key 411 for security processes by corresponding from the user account to the user private key 411.

(3) After the dedicated user private key 411 is generated, the user public key 412 is generated from the user private key 411; the user public key 412 is further signed off by the administrator through the administrator private key 511. Afterwards, the user digital certificate 413 generated by the signoff of the administrator private key 511, includes the user public key 412 generated by the user private key 411. The user digital certificate 413 granted by the administrator digital signoff is provided to the user for self-storage. When next time the user needs to conduct with security operations such as transaction, downloading merchandises or changing personal information, the administrator side will request the user to provide the he user digital certificate 413, and also verify the signoff of the user digital certificate 413 through the administrator digital certificate 513 (including the administrator public key 512). If the verification is passed, it means the user digital certificate 413 provided by the user is certificated and issued by the administrator side. Therefore, high security level operations are allowed and the user digital certificate 413 may be used to decrypt the content encrypted by the user private key 411.

The above-mentioned security features are concluded as follows:

(1) The user private key 411 cannot be obtained by any illegal user. Therefore illegal user or hackers cannot generate the corresponding user public key 412 from the user private key 411.

(2) The illegal user cannot obtain the certificate signed-off by the backend administrator private key 511 from the security mechanism of the backend service device 51.

(3) Even though the user digital certificate 413 signed off by the administrator is pirated or stolen to pass the verification of the backend security mechanism, the illegal user still needs to correctly log in the user account (through login password, identification, or any other identification information). Since the user account, the user private key 411 and the certificate are corresponding to each other, if a wrong user logs in an original user account, the wrong user's wrong user digital certificate 413 cannot decrypt the content encrypted by the user private key 411 corresponding to the original user account and vice versa. Therefore the security is still well protected.

(4) Since the corresponding relation between the user private key 411 and the user account is stored in only the server with the security mechanism, the user himself is not aware of it as well. Therefore, the security is higher.

In the present embodiment, the service mechanism is differentiated into the frontend service device 41 and the backend service device 51, each having their dedicated database 11. The frontend service device 41 includes the user private area 611 for every user and the joint area 612 for all users. The user private area 611 is the space where the user can operate after logging in; here the user can conduct with personal settings and upload the “legal” (signed off and granted by the administrator private key 511), user digital certificate 413, and in the meantime conducting security operations (such as decryptions), when purchases or download intangible merchandises through the user digital certificate 413. In the user joint area 612, all the involved services include the aforesaid posting advertisement and propaganda or uploading demands, searching, editing and accessing, and interacting/communicating between the users.

As to the service section of the backend service device 51, the user may conduct operations including uploading, searching, purchasing, downloading, editing and operating the intangible merchandise, which also includes the requests for various information such as user personal information, user merchandise list, user credit ranking, attribute trends, or transaction details, classifications and information of various virtual objects. When the user purchases or downloads the intangible merchandise, the backend service section retrieves the user private key 411 corresponding to the user account and the user digital certificate 413 uploaded by the user, and then verifies the signoff of the user digital certificate 413, verifying through the administrator digital certificate 513 to inspect if the source of the user digital certificate 413 is reliable. When passing the verification, the transacted intangible merchandise, the result of the transacted intangible merchandise calculated by a Hash Table or the results of various security algorithms, are encrypted by the user private key 411 (e.g. using RSA encryption technology), and then transmitted to the frontend service device 41, afterwards the user digital certificate 413 is used for decryptions.

The security procedure in the duration may be a single or multiple time steps, forward and backward between the frontend service device 41 and the backend service device 51, thereby ensuring the flexibility and reliability of signoff verification. Eventually the user obtains the intangible merchandise decrypted by his legal user digital certificate 413. If the used user digital certificate 413 is illegal or the login account is not correct, the user cannot obtain the transacted intangible merchandise correctly.

The downloading of the purchased intangible merchandise may be executed instantly or non-instantly. An instant transmitting means when the user purchases the intangible merchandise, the intangible merchandise is immediately verified by the transaction platform and downloaded into the user terminal apparatus 30. The user terminal apparatus 30 may be realized by PC, NB, handheld devices, tablet computers, or any other electronic devices capable of surfing on the internet. Afterwards, the user can start using the intangible merchandise. Such type of downloading, aside from receiving the digital or video/audio files, includes online streaming playback are all includes in the instant transmitting.

As to non-instant transmitting, it means when the user chooses to purchase the intangible merchandise, the transacted intangible merchandise is not directly downloaded to the user terminal apparatus 30, instead the transacted intangible merchandise is stored in the personal user space in the server 20 (which may be the frontend database 11 or the backend database 11). The user is allowed to actually download the transacted intangible merchandise anytime and anywhere, so that environmental issues such as the internet bandwidth problem, the available storage space of the user terminal and security reasons may be resolved.

However, if the transacted intangible merchandise is an instant online streaming playback file, when the bandwidth is not enough, the user can choose to playback later. The authorized playback times and duration will be recorded into the user space, so that the user is able to freely choose the playback time and location. The benefits of the buyer and the supplier are both ensured.

When purchasing or downloading the intangible merchandise, the service mechanism of the frontend service device 41 and the backend service device 51 may have flexibility by using the user private key 411 and the user digital certificate 413, complying with the administrator private key 511 to conduct various kinds of encryption/decryption and security verification according to the actual situations and demands.

The present disclosure achieves an e-commerce transaction system and method for self-made self-created intangible merchandises, as well as an e-commerce transaction system for not only the intangible merchandises, but also the self-made self-created related introductions and advertisements, or the user paid (active type), self-uploading, self-marketing introductions and advertisements.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An e-commerce transaction method for intangible merchandises, comprising:
logging in a web portal to upload or download an intangible merchandise, or to upload or download a demand corresponding to the intangible merchandise, or to provide an information correlated or unrelated to the intangible merchandise;
storing the intangible merchandise, the demand and the information through a database;
protecting, encrypting and verifying a login information, a transaction procedure and the intangible merchandise through a security verification module; and
operating the web portal through a server and a network transmission interface.

2. The method according to claim 1, wherein the intangible merchandise is selected from the group consisting of self-created experiences, knowledge, wisdoms, arts, intelligences, methods, concepts, improvisations, creations, know-how, researches, secret prescription and humanity exploration and any combination thereof, and the demand and the information are respectively digital electronic files of videos, audios, texts, images, application programs of self-made self-created introductions, sample files, demo files, advertisements and propagandas or any combination thereof.

3. The method according to claim 1, wherein the web portal is provided for a user to operate procedures of login, register, identification, paid download, paid online playback, editing personal information, amendments, encryption and decryption and certification.

4. The method according to claim 1, wherein the database comprises a user information unit, a message exchange data unit, a transaction record unit, a plurality of storage units and a credit ranking unit, the plurality of storage units corresponding to the stored intangible merchandise, the demand and the information.

5. The method according to claim 1, wherein the security verification module allows a user to operate procedures of payment, purchase, file transmission, verification of login information and transaction through the security verification module.

6. The method according to claim 1 further comprising operating a frontend service device through a user terminal and operating a backend service device through the server, wherein the user terminal is operable through an operating environment interface, a upload information unit, a download information unit, an editing-access unit, a search unit or a communicating unit.

7. The method according to claim 6, wherein the operating environment interface comprises a private area for the user to log therein, and edit personal setting, upload a legal user digital certificate, purchase a temporary space and download the intangible merchandise, the purchased intangible merchandise is stored into a private space of the frontend service device or the backend service device, the user selecting a time, place or interface to download the purchased intangible merchandise.

8. The method according to claim 6, wherein the operating environment interface comprises a joint area provided for the users an area jointly used for services of posting advertisement, sample files, demo files, propaganda or uploading demands, searching, editing and accessing, and interacting/communicating between the users.

9. The method according to claim 6, wherein the backend service device receives identification information of a registered member and confirms the identification information is legal, the backend service device produces a user private key and a corresponding user public key, the user being not capable of directly accessing the user private key, the user private key being provided only through the server according to the corresponding user account.

10. The method according to claim 9, wherein the user public key signs off and grants a user digital certificate to a user through a dedicated administrator private key, and the user digital certificate being provided next time, the signoff of the user digital certificate is verified to confirm its legitimacy by an administrator public key or an administrator digital certificate generated by the administrator private key of the backend service device.

11. An e-commerce transaction system for intangible merchandises, comprising:
a network transmission interface, connecting to a public or private network;
a web portal, loggable through the network transmission interface, so as to upload or download an intangible merchandise, or to upload or download a demand corresponding to the intangible merchandise, or to provide an information correlated or unrelated to the intangible merchandise;
at least a database, storing the intangible merchandise, the demand and the information through a database;
a security verification module, protecting, encrypting and verifying a login information, a transaction procedure and the intangible merchandise; and
a server, operating the web portal through the network transmission interface.

12. The system according to claim 11, wherein the intangible merchandise is selected from the group consisting of self-created experiences, knowledge, wisdoms, arts, intelligences, methods, concepts, improvisations, creations, know-how, researches, secret prescription and humanity exploration and any combination thereof, and the demand and the information are respectively digital electronic files of videos, audios, texts, images, application programs of self-made self-created introductions, advertisements and propagandas or any combination thereof.

13. The system according to claim 11, wherein the web portal is provided for a user to operate procedures of login, register, identification, paid download, paid online playback, editing personal information, amendments, encryption and decryption and certification.

14. The system according to claim 11, wherein the database comprises a user information unit, a message exchange data unit, a transaction record unit, a plurality of storage units and a credit ranking unit, the plurality of storage units corresponding to the stored intangible merchandise, the demand and the information.

15. The system according to claim 11, wherein the security verification module allows a user to operate procedures of payment, purchase, file transmission, verification of login information and transaction through the security verification module.

16. The system according to claim 11 further comprising operating a frontend service device through a user terminal and operating a backend service device through the server, wherein the user terminal is operable through an operating environment interface, a upload information unit, a download information unit, an editing-access unit, a search unit or a communicating unit.

17. The system according to claim 16, wherein the operating environment interface comprises a private area for the user to log therein, and edit personal setting, upload a legal user digital certificate, purchase a temporary space and download the intangible merchandise, the purchased intangible merchandise is stored into a private space of the frontend service device or the backend service device, the user selecting a time, place or interface to download the purchased intangible merchandise.

18. The system according to claim 16, wherein the operating environment interface comprises a joint area provided for the users an area jointly used for services of posting advertisement, sample files, demo files, propaganda or uploading demands, searching, editing and accessing, and interacting/communicating between the users.

19. The system according to claim 16, wherein the backend service device receives identification information of a registered member and confirms the identification information is legal, the backend service device produces a user private key and a corresponding user public key, the user being not capable of directly accessing the user private key, the user private key being provided only through the server according to the corresponding user account.

20. The method according to claim 9, wherein the user public key signs off and grants a user digital certificate to a user through a dedicated administrator private key, and the user digital certificate being provided next time, the signoff of the user digital certificate is verified to confirm its legitimacy by an administrator public key or an administrator digital certificate generated by the administrator private key of the backend service device.
